(19) United States
(12) Patent Application Publication
(10) Pub. No.: US 2004/0236859 A1
(43) Pub. Date: Nov. 25, 2004

(54) Method for transmission of classified and prioritised information

(76) Inventors: Geirr I. Leistad, Sandvika (NO); Hans Gude Dudesen, Brussels (BE)

Correspondence Address: BIRCH STEWART KOLASCH & BIRCH, PO BOX 747, FALLS CHURCH, VA, 22040-0747, US

(21) Appl. No.: 10/469,424

(22) PCT Filed: Feb. 27, 2002
(86) PCT No.: PCT/NO02/00082

(30) Foreign Application Priority Data
Feb. 28, 2001 (NO) 2001 1022

(51) Int. Cl. G06F 15/16

(52) U.S. Cl. 709/230; 709/201

(57) ABSTRACT

In a method for making more effective the end user's (5) access to and exploitation of information which is offered by a global information provider 5(4), wherein the information consists of dynamic data, quasi-static data, static data or a mixture thereof, including static databases, films, music, text etc. which for the end user's utilization in principle only needs to be transmitted once from information provider (4) to end user (5), the information which is offered on data files is classified with a unique classification key for each data file and priority protocols generated for transmission of data files on basis of a priority matrix which comprises elements formed by criteria for a transmission, said elements stating combinations of these criteria. Each classified data file is assigned to at least one priority protocol which is selected among generated priority protocols on the basis of the classification key of the data file, the assigned priority protocol stating the conditions for the transmission of the data file. The communication channels for a transmission is selected on the basis of the assigned priority protocol. Information is accessed in one of the following modes: (I) information is transmitted directly to the end user according to a predetermined or modified priority protocol or according to a priority protocol assigned for the occasion; (II) information is transmitted default and automatically directly to one of more end users according to a predetermined priority protocol; (III) information is transmitted according to an assigned priority protocol and stored in physical proximity to the end user.

The present invention concerns a method in transmission of information in the form of data files via a data communication network or in the form of data files stored on physically transportable data storage means, wherein the data files comprises digitally encoded information offered by global information providers and also including information which basically is offered on a shared network resource, e.g. Internet, wherein the information essentially comprises dynamic data, quasi-static data, static data or a mixture of such data, wherein the static data includes archival information or source information, including static databases, films, music, text etc. which for the end user's utilization in principle only need to be transmitted once from a global information provider to end user, wherein the transmission of information takes place in an open communication domain which includes proprietary or public data communication networks as well as surface mail systems.

A large part of the information which is offered by information providers linked to existing data communication networks comprises data which only need to be transmitted once from information provide to end user. Such data may basically be stored at the information providers or memories which makes possible the readout or downloading with extremely high data rate. The readout rate can hence with the use of suitable interfaces easily be adapted to data communication channels with extremely high bandwidth even though this extremely high bandwidth for communication between the information provider and end user is only available for short periods of time. This in its turn makes it possible to avoid that information of this kind, i.e. information which comprises large data volumes, burdens common two-way data communication networks, but instead can take place with the use of communication networks which are optimized for one-way transmission, e.g. satellite-based channels or broadband cable networks.

From U.S. Pat. No. 6,044,405 (Driscoll & al.) assigned to Wam!Net Inc. there is known a method which concerns data transmission networks and particularly a method whereby a provider-operated data transmission service can transmit large data blocks with high speed to customers or clients or between geographically remote locations. Particularly this publication concerns a method wherein a document is transported from a sender to a primary node in a service network, the primary node being closer geographically to the sender than the receiver. Simultaneously an electronic invoice is linked to the document. This invoice shall contain document criteria for the documents uniquely identifying the document and criteria which identifies a characteristic attribute connected with a price for the transmission of the document to the receiver, the price being determinable before the transmission is completed whereafter the document is transmitted to the service network from the primary node to a secondary node which is located geographically closer to the receivers than the sender and thereafter is transported from the secondary node to the receiver, the criteria which identify characteristic attributes being used for determining the transmission cost. In connection with the transmission of the document there are in the service network included a document-specific information generator which on the basis of given information generates document specific information, including criteria for uniquely identifying the document and criteria generated as a response to a characteristic attribute connected with a fee for transmission of the document, the fee being determinable on the basis of the last-mentioned criteria for the transmission of the document between the nodes. U.S. Patent No. 6,044,405 does, however, not disclose how information which not without problems can be transmitted from an information provider to an end user on a shared network resource, can be transmitted optimally in an open communication domain without an unnecessary load on the data transmission paths in this domain. Neither can there in U.S. Pat. No. 6,044,405 be found a disclosure that on the basis of a classification of information which is to be transmitted, it is possible to adapt a transmission in a way which guarantees end user's full satisfaction with regard to time and transmission costs. An insight of this kind is a part of the background of the present invention, something which shall be further elucidated in the following.

The information providers shall in the following be understood as global information providers, i.e. information providers which in principle offer information to end users globally and without restriction, in other words information which is available to all and sundry. The information which the information provider stores can consist of dynamic or static data. By dynamic data there shall in this connection be understood data which change often and continuously, such that the volume of valid data varies all the time. Static data however, are changing seldom or do not change at all. These two categories of data, dynamic and static, indicate two outer limits for the data volatility. In reality the amount of data shall fall between these two outer limits. An example is archival information, e.g. books, films, music etc., which is permanent and static data. Data such as the last weather report and the latest stock rates will, however, quickly change and are hence dynamic. The volatility of these data may hence vary. On the other hand can weather reports or news be valid over shorter or longer duration and hence being regarded as static as long they are valid, even though the data in the longer term are dynamic. Dynamic data may become static if they e.g. are incorporated in time series which are unrestricted valid. The same applies to dynamic data which concern single events, but which regarded as historical data change to be static and valid for unlimited periods of time. The data which in the short term are dynamic, can hence in another context be unrestricted valid and thus static. This implies that information also may comprise quasi-static data or a mixture of all data types, i.e. dynamic, static and quasi-static data. Information consisting of static data probably contains larger data volumes than other types of data and will hence with regard to data volume be the most resource-demanding when data are to be transmitted from information providers to end user. This has as a consequence that the transmission of such data in two-way data communication networks and particularly on a shared network resources such as Internet, shall demand large transmission resources and lead to traffic problems. Simultaneously shall these two-way networks handle data transmissions which basically are to be regarded as real time communications, e.g. message transmissions between the for operators active in the network. Basically it will hence be desirable to be able to transmit large volumes of static information in other ways than through two-way data networks, such that these will be free to handle ordinary message communications and real time transmissions, e.g. of dynamic data, the validity of which being limited such that it is necessary that they are transmitted very fast and without traffic-related impediments.

A first object of the present invention is hence to provide a method which allows particularly information in the form of substantially static data to be transmitted from the information provider according to some protocol or other and directly to one or more end users and preferably to be transmitted such that if there are more than one end user, the transmission takes place approximately simultaneously.

A second object of the present invention is that the same information only shall be transmitted once such that end user's access of the information does

not require a new transmission each time end user wishes to access the information.

A third object of the present invention is simultaneously to liberate transmission capacity in two-way networks or shared network resources such that they more efficiently can handle two-way transmission in real time or dynamic data or data with limited validity.

It is further a fourth object of the present invention that end user's access of the data for utilization shall take place instantly or approximately instantly, even though the time which has passed during transmission from the information provider to end user is arbitrarily long.

Yet further it is a fifth object of the present invention that the information provider with basis in the data type and the data validity automatically, particularly to file-formatted information, can assign predetermined priority criteria, such that the information default in any case is transmitted in a determined mode.

Finally, it is a sixth object of the present invention to offer end user a possibility to assign priority to the transmission on his own with given or selected criteria such that the transmission is optimized with regard to e.g. speed or transmission cost.

The above objects and other feature and advantages are achieved according to the present invention with a method which is characterized by classifying information offered with a unique classification key comprising a set of respective qualified quantitative and qualitative classification criteria, such that each data file is assigned a unique classification key, generating priority protocols for the transmission of data files on the basis of a priority matrix comprising elements formed by two or more qualified criteria for a transmission, the elements of the priority matrix stating valid combinations of these criteria, assigning each classified data file at least one priority protocol selected among the generated priority protocols on the basis of the classification key for the data file, the priority protocol assigned to a data file determining the conditions whereby transmission of the data file shall take place, selecting one or more channels for direct or indirect transmission of a data file from a global information provider to one or more end users on the basis of a priority protocol assigned to the data file, accessing information transmitted in one or more data files in one of the following modes: (I) the data file or the data files are transmitted directly to end user according to a predetermined priority protocol or to a priority protocol assigned for the occasion; (II) the data file or data files are transmitted default and automatically to one or more end users according to a predetermined priority protocol; (III) the data file or data files are transmitted to a predetermined priority protocol or a priority protocol assigned for the occasion and transmitted information is stored physically in proximity to end user such that the transmitted information thereafter is available for end user's instant or approximately instant access by storage of the transmitted information taking place on a mass storage device of a local server which serves one or a limited number of end users or on a corresponding mass storage device of the end user, the information in each case now being accessible over a direct connection between end user and mass storage device.

In the method according to the invention it is regarded as advantageous that the classification key comprises at least the following criteria, viz. information type, age, volume, number of users and user relevancy, each of the criteria being qualified in ranked categories.

In the method according to the invention it is regarded as advantageous that the priority matrix is formed on the basis of at least two of the following criteria for transmission, viz. transmission mode, data rate, transmission cost and delay/urgency, each of the criteria being qualified in ranked categories.

Finally, it is in the method according to the invention regarded as advantageous that the priority protocol is assigned to the data files by a global information provider.

In the method according to the invention it is also regarded as advantageous that the global information provider in advance determines the priority protocol determines whereby the transmission in any default case takes place. In that connection end user can advantageously be offered a survey of the priority protocols assigned to a data file and on his own choose the priority protocol whereby the transmission of the data file shall take place, or from the global information provider be offered the choice between several priority protocols for transmission of a data file to end user, such that the transmission takes place with priority protocol selected by end user or with priorities determined by the latter.

Advantageously data files consisting of dynamic data are transmitted dependent on the assigned priority protocol via two-way data communication networks, including two-way data communication networks in a shared network resource, while data files consisting of static data are transmitted dependent on the assigned priority protocol in the open communication domain by data communication networks optimized for one-way communication with large capacity, the transmission taking place as an only once transmission with high transmission rate, in batches with aggregated medium transmission rate or continuously with a low transmission rate over a longer time period. Alternatively can data files consisting of static data be transmitted dependent on the assigned priority protocol in a single operation by the information being transferred to a physically transportable memory device which then is physically transported to end user.

In a first advantageous embodiment of the method according to the invention, wherein end user access takes place in mode III, a global information provider delivers the information to local servers and/or end users and by the global information provider transmitting the information to the local server or the end user in at least one of the following modes: (i) the information is transmitted from the information provider to a physically transportable mass storage device in a memory to memory transfer in a data processing device of the information provider and transmitted further to a local server or end user by a physical transport of the transportable mass storage device; (ii) the information is transmitted from the global information provider to a local server or end user via data communication networks which are optimized for one-way transmission with large capacity, such as satellites, ground-based wireless broadband channels or cable-based channels with broadband capacity.

In this first embodiment of the method according to the invention the transmission preferably takes place upon request from a local server or end user under a priority protocol which is determined on the basis of criteria specified by information provider or end user or both, the priority protocol being wholly or partly default or modified wholly or partly each time, or the transmission to a local server or end user preferably takes place automatically under a pre-agreed user subscription. In the latter case can then preferably the pre-agreed user subscription include respectively one or more global information providers or one or more end users.

In a second advantageous embodiment of the method according to the present invention, wherein end user access takes place in mode III, the global information provider delivers the information to one or more dedicated servers with mass storage capacity, and a dedicated server transmits the information to a local server or end user in at least one of the following modes: (iii) the information is transmitted from the dedicated server to a physically transportable mass storage device in a memory to memory transfer in a data processing device of the dedicated server and transferred further to a local server or end user by a physical transport of the transportable mass storage device; (iv) the information is transmitted from the dedicated server to a local server or end user via data communication networks which are optimized for one-way transmission with large capacity such as satellite channels, ground-based wireless broadband channels or cable-based channels with broadband capacity.

In this latter embodiment the transmission preferably takes place upon request from a local server or end user under a priority protocol which is determined on the basis of criteria specified by the global information provider or end user or both, the priority protocol being partly or wholly default or modified partly or wholly each time, or the transmission to a local server or end user takes place automatically under a pre-agreed user subscription. In the last mentioned alternative can then preferably the pre-agreed user subscription include respectively one or more information providers or one or more end users.

Wherein access takes place in mode III and the information is stored on a local server, can advantageously according to the invention a direct connection for information access between the local server and end user take place over a dedicated local broadband network or an arbitrarily selected connection between a local server and end user, the latter connection preferably be established by end user.

Further can advantageously according to the present invention the transmitted information be searched by the end user with a search engine and search index implemented on the local server or at the end user, and the search index is then generated by one of the following, viz. the global information provider, the local server or a dedicated server. If the information then alternatively is transmitted on a physically transportable mass storage device, the search engine and the search index preferably are integrated on the physically transportable mass storage device.

Finally can advantageously according to the present invention the transmitted information be searched with a search engine for non-indexed search, and if the information then alternatively is transmitted on a physically transportable mass storage device, the search engine for non-indexed search is integrated on the physically transportable mass storage device.

The invention shall now be explained more closely by way of examples of preferred embodiments with reference to the accompanying drawing figures wherein

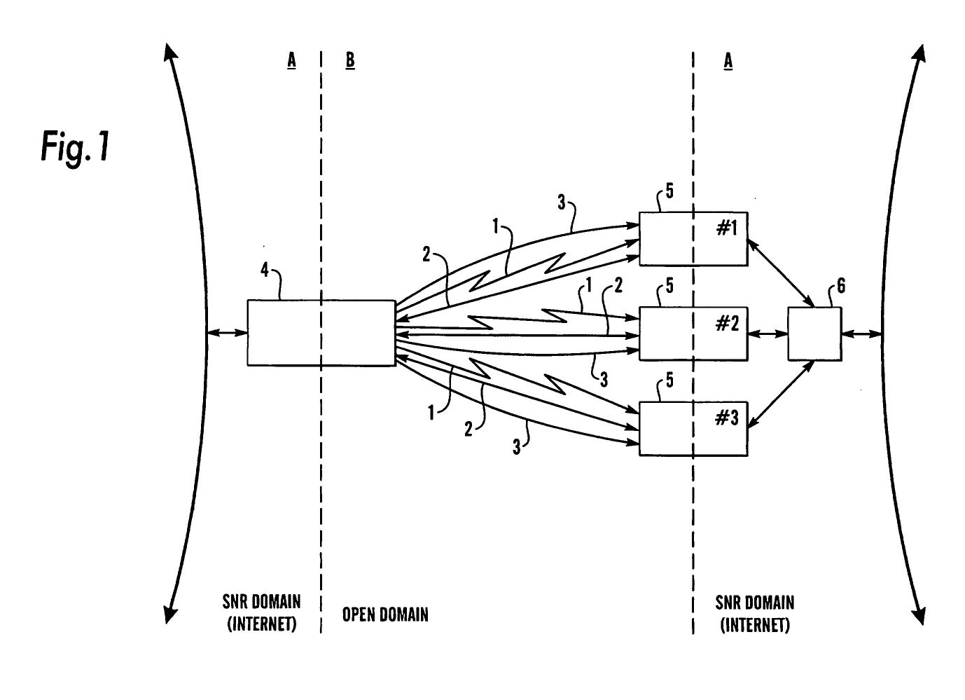

FIG. 1 shows a first alternative for transmission of information in the method according to the present invention,

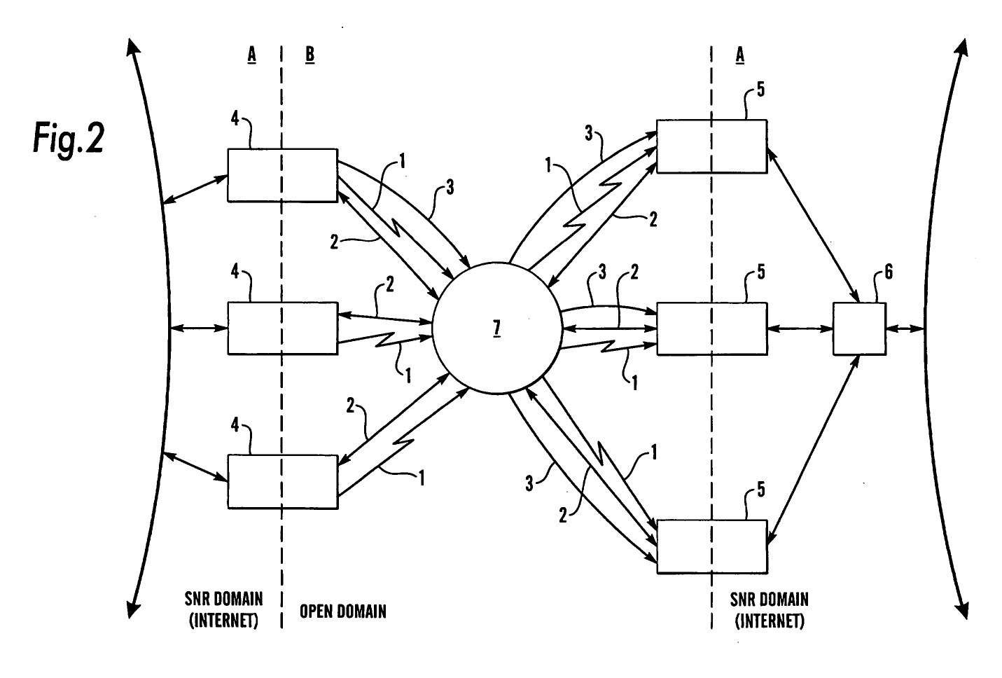

FIG. 2 a second alternative for transmission of information in the method according to the present invention,

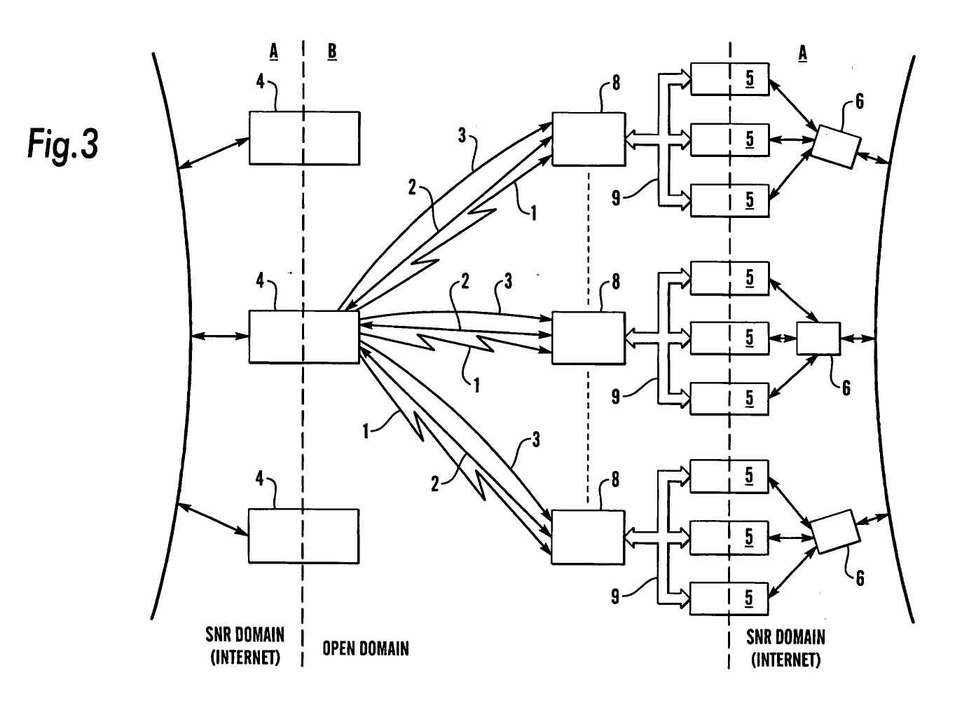

FIG. 3 a third alternative for transmission of information in the method according to the present invention, and

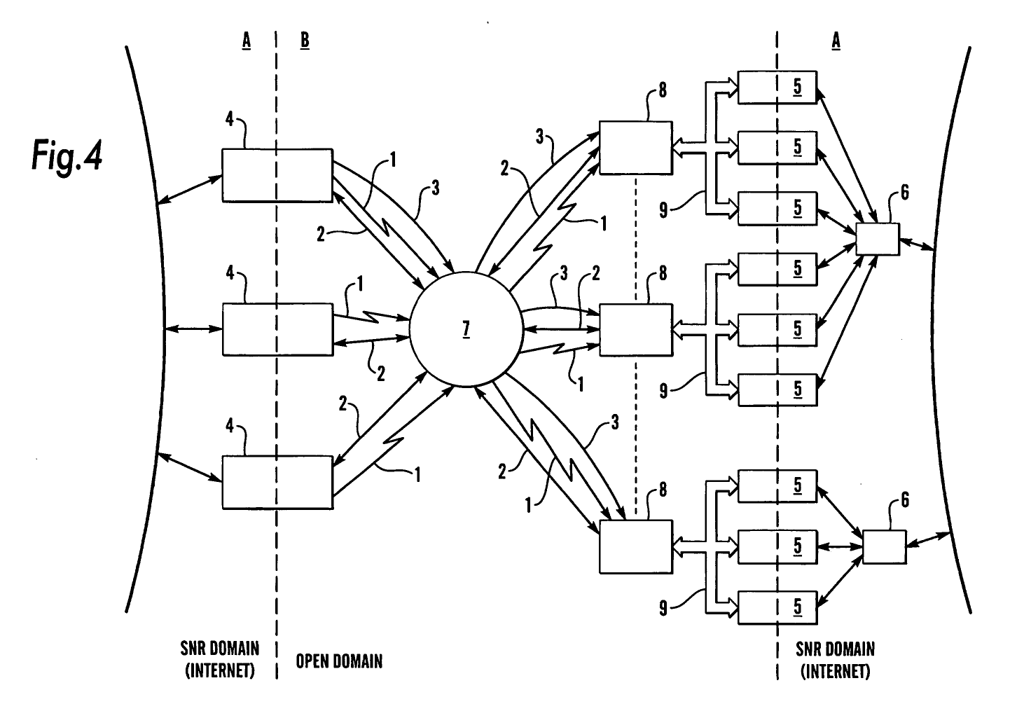

FIG. 4 a fourth alternative for transmission of information in the method according to the present invention.

The transmission of information from a global information provider to an end user takes place with the use of a priority protocol, the primary intention of which is to optimize the information transmission with regard to the requirements of the information provider or the end user or both. The priority protocol is based on criteria which are determined either with basis in the information type or properties of the information which shall be transmitted and further determined with basis in purely transmission-related criteria.

In the following description the transmitted information will be denoted as files or data files by which it is to be understood the complete named collection of transmitted information without any reference to specific file formats, e.g. for transmission storage or display. In other words, the concept file in the following also will be used for data streams to the extent that they make up the totality of information which is to be transmitted and it is to be understood that the concept as used also denotes information collections in make up the totality of information which is to be transmitted and it is to be understood that the concept as used also denotes information collections in the form of relatively continuous series formed by every small structural homogenous unit, e.g. byte or bit.

The information which shall be transmitted, hereinafter called the data file, can be classified with criteria as shown in table 1, wherein the first column enumerates the separate categories which are used for qualifying the criteria, row by row. The criteria are denoted from A toE, column-by-column, and qualified in up to 4 categories. A data file can hence according to table I in theory be classified by 3²·4³, in total 576 different ways.

The qualification in categories corresponds to a ranking of the separate criteria, something which reflects that both quantitative and qualitative categories are provided in an ordered sequence between two opposite extrema.

TABLE 1

| | Criterion A | | | Criterion D | |
|---|---|---|---|---|---|
| | Type of | Criterion B | Criterion C | Number of | Criterion E |
| Qualification | information | Age | Volume | users | User relevancy |
| 1 | Dynamic | ≦1 day | Large | >100 | High |
| 2 | Static | ≦1 week | Medium | 11-99 | Medium |
| 3 | Quasi-static | ≦1 month | Small | 2-10 | Low |
| 4 | — | ≦1 year | — | 1 | Undetermined |

In table 1 criterion A states the information type qualified as dynamic, static or quasi-static, criterion B the age of the data file and the time which has elapsed since the file was created or the data generated, criterion C the data volume e.g. stated in bytes, criterion D the number of users, i.e. the number of end users who shall receive information or have asked to receive information, whether this takes place on request or according to some subscription arrangement or other, and criterion E states the user relevancy. The last criterion can be stated beforehand, but will as a rule be specified by the separate user in connection with the transmission request or in connection volume and shall for instance be received by 2 to 10 users, the relevancy for all being stated as high. The data file is then classified with the criteria [A1B1C3D3E1] and can now default and automatically be assigned a priority protocol which ensures that the transmission from the information provider to the end user takes place in a suitable manner, e.g. with high data rate and high urgency, whereby the priority protocol is based on the criteria stated in the following table 2. This table gives criteria for a transmission and again the criteria are categorized in as far as possible in logical sequences.

TABLE 2

| | | | Criterion c | Criterion d |
|---|---|---|---|---|
| | Criterion a | Criterion b | Transmission | Delay/ |
| Qualification | Transmission mode | Data rate | cost | urgency |
| 1 | Continuous stream | High | Low | None/ |
| | | | | immediate |
| 2 | Batch | Medium | Medium | <1 hour |
| 3 | Continuous trickle | Low | High | <1 day |
| 4 | Memory transport | Indefinite | Indefinite | <1 week |
| 5 | — | — | None | Indefinite |

In table 2 the first criterion a gives the transmission mode, the second criterion b the data rate, the third criterion c transmission cost and the fourth criterion d the delay/urgency. The separate criteria are here qualified in up to 5 categories as stated in first column in table 2, and for criterion a, transmission mode, this may e.g. be qualified such that the data file is transmitted in a continuous stream or divided into batches or “trickle”, i.e. intermittently continuously, but fragmented in arbitrarily small units, and finally by physical memory transport such this shall be described in the following.

Criterion b, the data rate, is high, medium, low or indefinite and criterion c the transmission cost correspondingly low, medium high, indefinite, or none, i.e. such that the transmission in the latter case takes place without any costs for the provider or user. Finally criterion d states the urgency, i.e. the delay between a request or decision of transmission, such that the data file either is transmitted immediately, within a period of one hour or a period of one day or within a period of one week, possibly with an indefinite urgency. Based on the criteria stated in table 2 and qualified with the respective number of categories, the table implicates a total of 400 possible priority protocols for the transmission of a data file.

In the above example wherein the data file is classified as [A1B1C3D3E1] it may e.g. be natural to select a transmission mode as a1 or a2, the data rate as b1, i.e. high, the transmission cost as c4, i.e. as indefinite, such that the transmission costs shall play no role, and finally the urgency as d1 such that the transmission shall take place immediately, something which will be desirable with dynamic information particularly with a short term validity and where the user relevancy is stated as high. The data file classified as stated could hence for the transmission be assigned priority protocol [a1b1c4d1], unless an end user desires to modify that. It is in any case practical that a data file of the indicated type e.g. is assigned a priority protocol default and automatically if it is to be delivered to a large number of users. In regard of the transmission mode, criterion a, it can as stated in table 2 be qualified in four different ways. a1 states that the transmission takes place in a continuous stream, i.e. the data file is transmitted and unfragmented, the criterion a2 that the transmission takes place batchwise and fragmented but such that the batches are given a minimum size, but otherwise may be of varying length. This allows the exploitation of free transmission capacity, e.g. in time windows which arise in broadband channels. Further the transmission mode may also be qualified as a3 and the transmission will then take place continuously but as a trickle (continuous trickle mode), such that there are no minimum size of the information volume which can be transmitted uninterrupted. It may e.g. be as low as 1 byte or bit and hence exploit free capacity whether it is available with low bandwidth or low data rate.

Both in table 1 and table 2 are some criteria qualified with qualitative categories, e.g. criterion C which is the data volume, criterion b which is the data rate and criterion c which is the transmission cost. Probably it will, however, be closer at hand to use quantitatively qualified categories such that criterion C is qualified with data volume stated in bytes, criterion b with the data rate stated in bytes/s and criterion c with transmission cost stated as e.g. US$/byte. This will, of course, in practice be preferred and it will be obvious to a person skilled in the art how this may be done. Likewise it will be obvious that the number of categories used in any circumstance can be far larger and not limited to 3 to 5 as stated herein.

Finally, it will also be possibly to transmit the data files in a physical memory transport by the information provider e.g. transfers the data to a physical transportable memory, in practice a mass storage device in a memory-to-memory transfer and that this physically transportable memory then is physically transported, e.g. by ordinary mail or courier to e.g. a local server connected with one or more end users and directly to the end user himself. This corresponds to criterion a4. In each case can the physically transportable mass memory be installed on the specific recipient's own data processing device for accessing and downloading of data. It will be seen that if such a physically transportable memory has a large storage capacity, this could outweigh that a memory transport by mail or by means of courier can take from one to several days. For instance can a stored data file in a volume range of 1 Tbyte which is transmitted in this manner and received within a week, attain a transmission rate of about 1.6 Mbyte/s, something which would outperform most of the possibilities for a so-called broadband transmission which today is available to users. If the urgency then is larger than one week or indefinite, something which may well be the case if the information type is A2, i.e. static, and the data have long term validity, something which e.g. be the case for films, books, and various types of archival information, a physical memory transport of this kind could appear as an optimal solution as the transmission costs in practice will be completely independent of the data volume.

If the transmission of data filed shall take place electronically and in an open communication domain, this implies that a large number of electronic transmission paths, i.e. data communication networks will be available for the transmission. These data communication networks will as a rule have a specific network operator which with basis in a persistent traffic monitoring shall be able to offer information providers the transmission capacity on determined conditions. A priority protocol can in other words also be modified by the information provider on the basis of acquired information about networks and capacities deriving from the actual network operator. Regardless of this, the information provider or the one responsible for transmitting information must take in regard whether the qualifications of the applied transmission-related criteria are mutually compatible. This can take place with the use of a priority matrix with at least two and on the basis of the criteria stated in table 2 up to and including four dimensions.

There shall now be given an example how the priority protocol can be established with the use of priority matrix which is based on criterion a, transmission mode and criterion b data rate. This is shown in table 3 which discloses a two-dimensional matrix for transmission mode and data rate.

TABLE 3

| | b1 | b2 | b3 | b4 |
|---|---|---|---|---|
| a1 | 1 | 1 | 0 | 0 |
| a2 | 0 | 1 | 1 | 0 |
| a3 | 0 | 0 | 1 | 1 |
| a4 | 1 | 0 | 0 | 1 |

An allowed combination is given by 1, a not allowed combination is given by 0. As will be seen a continuous stream shall allow high data rate or a medium data rate, but trickle transmission only allows low to indefinite data rates, in other words the combination a3b3 or a3b4. The paradox of transmission with a physical memory transport is evident from the combination a4b1, i.e. the transmission can take place with high data rate or by the combination a4b4 which implies that the data rate may be wholly indefinite. The table discloses as will be seen a 4·4 array, but only half of the possible combinations can be used. This can in its turn be used for expanding a two-dimensional priority matrix into a three-dimensional priority matrix, e.g. by taking into account criterion c, transmission cost, or criterion d, delay/urgency, such this is shown respectively in the following table 4 and table 5.

TABLE 4

| | c1 | c2 | c3 | c4 | c5 |
|---|---|---|---|---|---|
| a1 b1 | 0 | 0 | 1 | 0 | 0 |
| a1 b2 | 0 | 1 | 1 | 0 | 0 |
| a2 b2 | 0 | 1 | 1 | 0 | 0 |
| a2 b3 | 1 | 1 | 0 | 0 | 0 |
| a3 b3 | 1 | 0 | 0 | 1 | 1 |
| a3 b4 | 1 | 0 | 0 | 1 | 1 |
| a4 b1 | 1 | 0 | 0 | 0 | 0 |
| a4 b4 | 1 | 0 | 0 | 0 | 1 |

The combination of transmission mode a with a data rate b and transmission cost c in table 4 in reality forms a three-dimensional priority matrix wherein the criteria mentioned constitute the respective dimensions. Only the 8 valid ones of in total 16 possible combinations in the matrix in table 3 are used to form the priority matrix in table 4, which with criterion c qualified in 5 categories hence obtains 40 possible combinations, but only 16 of these are stated as valid. The number of priority protocols based on the criteria a,b, and c will hence be limited to 16. From the priority matrix in table 4 it will be seen that the priority low transmission cost c1 is not possible to combine with a desire for a high data rate, i.e. b1, unless memory transport is selected as transmission mode. The priority protocol will in this case in other words be [a4b1c1]. Not unexpectedly batchwise or continuous transmission with high to medium data rates leads to high transmission costs and the only possible priority protocols will in these cases be [a1b1c3], [a1b2c3], [a2b2c3], [a1b2c3] or [a2b2c2]. With the object of optimizing transmission mode and data rate combined with low cost the protocols [a1b2c2] or [a2b2c2] perhaps will appear as preferred ones. Priority protocols based on the three-dimensional array as disclosed in table 4, namely with transmission criteria a,b and c may of course now be assigned to different types of data files classified according to the criteria in table 1, either default or automatically by the information provider or modified e.g. by end user in connection with a request or a transmission subscription. It shall, however, also be understood that on basis of information from the network operator it may from time to other be possible to modify the priority matrix such that priority protocols which usually are not valid, temporarily can be valid, e.g. due to time-limited additional transmission capacities or special offers from the network operators.

TABLE 5

| | d1 | d2 | d3 | d4 | d5 |
|---|---|---|---|---|---|
| a1 b1 | 1 | 1 | 0 | 0 | 0 |
| a1 b2 | 0 | 1 | 1 | 0 | 0 |
| a2 b3 | 0 | 1 | 1 | 0 | 0 |
| a2 b3 | 0 | 0 | 1 | 1 | 0 |
| a3 b3 | 0 | 0 | 0 | 1 | 1 |
| a3 b4 | 0 | 0 | 0 | 0 | 1 |
| a4 b1 | 0 | 0 | 0 | 1 | 1 |
| a4 b4 | 0 | 0 | 0 | 0 | 1 |

Table 5 shows the priority matrix for the transmission criteria a,b and d, and discloses 40 possible combinations, but in practice only 14 of these appear as valid in the here shown three-dimensional priority matrix. For instance will urgency d qualified in category 1, i.e. the transmission shall take place immediately, result in that it only can take place continuously with high data rate. If the matrix in table 4 is combined with the matrix in table 5 into a four-dimensional matrix, it will however, be seen that this only can take place with high cost, consequently in accordance with a priority protocol [a1b1c3d1]. A protocol of this kind can e.g. default be assigned to a data file which is classified as [A1B1C3D4] i.e. that the data file contains dynamic data with age lower than 1 day, that the data volume is small, that there is only one user and that the user relevancy is high. A file of this kind shall in other words by using the disclosed priority protocol be transmitted continuously with high data rate, high cost and high urgency, i.e. instantaneously. A data file classified as [A2B4C1D2E4] can on the contrary default be assigned a priority protocol wherein criterion c, transmission cost, is qualified as low and the urgency up to one week. Allowable urgency d4, i.e. up to one week, may according to the priority matrix of table 5 be combined with a2b3, a3b3 or a4b1, and this can according to table 4 also be compliant with the requirement that the transmission costs shall be low, i.e. the transmission can now take place with priority protocols [a2b3c1d4], [a3b3c1d1] or [a4b1c1d4]. A high data rate combined with low cost can in other words be only combined with a physical memory transport, consequently the priority protocol will be [a4b1c1d4]. A protocol of this kind can default be assigned the above-mentioned data file classified as [A2B4C1D2E4], i.e. with static data, one year old or older, large volume, 11 to 99 users and indefinite user relevancy. A priority protocol where all four transmission criteria shall be valid can be formed on the basis of a four-dimensional priority matrix, i.e. priority matrix which combines criteria a,b,c and d. This priority matrix could e.g. be created by combining the sixteen valid protocols of table 4 with the 5 categories which qualify criterion d4, urgency, and hence shall provide 80 possible priority protocols. Of course, not every one of these will be valid and applicable for a transmission. It will be obvious to persons skilled in the art how valid priority protocols may be created from the four-dimensional priority matrix on the basis of every transmission criteria a,b,c and d and this will thus not be discussed in closer detail here.

With regard to assignment of optimum priority protocols for a given file classification the categories of transmission criteria can be weighted with multipliers which e.g. are set by the information provider or end user. The weighting then quantifies the desired priorities in some order of rank or other and the weighting products for valid priority protocols hence makes it possible to compare relevant priority protocols in order to achieve an optimum transmission of data files. Procedures of this kind shall be well-known to persons skilled in the art and will hence not be further discussed here.

Evidently it will be possible to establish priority protocols for determined file classifications such that they without further ado can be transmitted on a shared network resource as e.g. Internet. However, basically the object of the present invention is to avoid the transmission on a shared network resource wherein neither the information provider nor the end user in principle have any possibility of influencing the transmission and wherein also the transmission of larger files, e.g. with static information, in reality is not an optimum solution and in addition not always will be possible to realize. The present invention hence takes as its point of departure that the transmission of the data files shall take place on communication paths in an open communication domain where it will be possible to freely choose networks and transmission resources e.g. under subscription arrangements or more or less permanent offers from network operators. Based on available information about transmission resources in an open communication domain, valid priority protocols can be established, optimizing the transmission according to criteria given by the information provider or selected by end user. Simultaneously it is achieved that the transmission shall take place in a manner which does not burden the communication networks unnecessarily, such that the ordinary data traffic such as message communication will not be hurt.

FIG. 1 shows alternative data communication paths 1,2,3 in an open communication domain B. These data communication paths can be used for transmitting information from a global information provider 4 to end users 5. The global information provider 4 may also be localized in domain A formed by a shared network resource (SNR) which may well be Internet and hence the SNR domain in the following will be denoted as Internet or the Internet domain. The global information provider 4 can thus also be regarded as a common web server and for the purposes of the present invention a global information provider could be regarded as consisting of a web server and a proxy server in respectively the Internet domain A and the open domain B. The data communication paths 1,2,3 in the open domain are i.a. formed of data networks which in contrast to the data networks which handle the traffic on Internet, is not made subject to TCP/IP (Transmission Control Protocol/Internet Protocol). This implies that operator in the open domain whether they are information providers, proxy servers or end users freely can choose network connection and that such specific network connections generally are offered by the network operators. In FIG. 1 the connections among others shown as one-way broadband channels 1 which at least can comprise different forms of satellite communication or broadband cable systems, possibly also ground-based wireless data communication systems, or as two-way telecommunication lines 2 which shall be understood as the ordinary telecommunication network which principally handles various forms of message traffic, but also is available for data communication. There is of course nothing to prevent that such two-ways telecommunication lines 2 can offer broadband capacity, but as they in principle are freely available for all operators in the open communication domain B, each and every one comprises a plurality of channels which with normal telecommunication activity will be occupied a large part of the time and further each can only offer a limited bandwidth. One-way broadband channels will on the contrary make possible the transmission of large data volumes in short time, something which is exemplified in that they usually are applied for transmitting television and video information which require larger bandwidth than ordinary voice and text communication. The data communication paths 1,2 in the open domain in FIG. 1 see to that the global information provider 4, i.e. in this case a proxy server in this domain B can deliver information according to a priority protocol to end users 5 over a data communication path selected on the basis of the priority protocol, which of course not in any case will be regarded as identical with the transmission or communication protocol which will be specific for a transmission in a selected data network. As there are regional and diurnal variations in the degree of utilization of the data communication network, such variations can for instance on the basis of information from the network operators be used by the global information provider to ensure e.g a speed- and cost-optimized transmission to end user. Where the information is transmitted automatically and default to one or more end users, e.g. in subscription, the information hence normally will take place on a determined type of data communication network such that the transmission of information with basis in the data type, i.e. whether it is dynamic or quasi-static or static and dependent on the data validity, takes place in an optimum manner to end users in any case. Here also the volume of the files that shall be transmitted is relevant.

As alternative transport path for the transmission in a data communication network in an open domain B the information could, however, be transported physically over a suitable transport path 3 and stored on a memory device formed for the purpose. The global information provider 4 will in this case be able to transfer the offered information in a direct memory-to-memory transfer to a physically transportable memory in his proxy server and then physically transport this memory, e.g. in any suitable manner including ordinary mail service, courier service or other, to an end user. Paradoxically the transmission rate in such cases, dependent on the memory having sufficiently large capacity and containing a large data volume, may be high compared with the transmission rate of ordinary data communication networks in the open domain, such that a physical transport of a transportable memory device for end user 5 may be an efficient and cost-effective manner of information transmission, given that the data have approximately unlimited validity. For instance may a memory device which contains 1 Tbit and which is delivered by courier from the global information provider to end user within a couple of days, imply a data rate of about 10¹² bits/1,75·10⁵ s, i.e. at least 5·10⁶ bits/s, something which would occupy two to three 2 Mbit/s channels in a correspondingly long period and with comparatively far higher transmission costs than would be the case of a courier service.

As shown in FIG. 1 the end users 5 may also be operators in the Internet domain A and users of Internet. For end users or information providers it is hence possible to assign a priority protocol which with basis in the data type, e.g. where the information consist of dynamic data with short-term validity and the file size is manageable, would lead to that the information is transmitted on Internet with the use of HTTP as transport protocol. In a usual manner the web server of the global information provider 4 and end user 5 is then connected via Internet and the information is delivered to end user from a service provider 6 (ISP; Internet Service Provider) on Internet.

FIG. 2 show a second alternative for the transmission of information between global information providers 4 and end users 5. In contrast with the variant of FIG. 1 it is here in the open domain B implemented a dedicated communication server 7 which also may implement a communication node. A plurality of global information providers 4 is connected via their proxy servers to the dedicated communication server 7 for transmission of stored information according to demand. Information transmission can take place via one-way broadband channels 1 or two-way telecommunication lines 2 depending on the information types and data validity. As before, the web server of a global information provider 4 may also deliver data over Internet to the end users 5. In the present alternative, however, the advantage gained is that the global information providers which offer static information of the same kind, e.g. static source information such as films and music, can co-ordinate the offers such that the end user 5 can request and access the same type of source information irrespective of where the source information originally is generated or from where it is originally is offered. A further advantage here is, since the information transmission from the information provider 4 to the dedicated communication server 7 is not dependent on end user demand, it can take place more or less continuously as the information is generated and hence in principle needs not occupy a large bandwidth capacity, but e.g. utilizes channels which are available in two-way telecommunication lines, as source information of this kind can be stored on suitable memory devices in the dedicated communication server 7 and also be made available for searching from the end user 5 with regard to downloading thereto. A search of this kind implemented by the end user may e.g. take place with the use of search indexes and search engines which are accessed on Internet and hence it is implicit, but not shown in FIG. 2, that the dedicated communication server 7 in the Internet domain A for this purpose may well include a web server which implements the search engine and search index. As a more or less continuous transmission of such information from the global information providers 4 implies a collective updating of the information on the dedicated communication server 7, it its for retrieval purposes advantageous that the dedicated communication server possibly indexes the information continuously, such that search and retrieval of the information present on the communication server is possible at any time.

For transmission to end user 5 the dedicated communication server 7 now as before implements priority protocols automatically and default, but may yet offer an end user 5 to modify the priority protocol as required, e.g. based on evaluations of the cost of the transmission or the user relevance. The dedicated communication server 7 can of course, also serve one or more end users 5 under subscription arrangements, the transmission of information then preferably taking place with the use of a default priority protocol. As a transmission alternative one also has the possibility to undertake a memory-to-memory transfer to the dedicated communication server 7 and then physically transport a transportable memory device on a suitable transport path 3, e.g. via mail or courier service to end user. In principle there is nothing to prevent that information on the dedicated communication server 7 could be transmitted via the Internet domain, but taking in regard transmission capacities and transmission speeds on Internet and the type of the information that above all would be natural to download to the dedicated communication server 7, viz. static and archival data with unlimited validity, i.e. source information such as films, music, larger text books or larger databases of various types, a transmission on Internet in all probability would appear less favourable with regard to transmission rates and costs.

FIG. 3 shows a third variant of the data communication paths between global information providers 4 and end users 5. As before can the global information providers 4 in the Internet domain A comprise a web server which delivers information over Internet and further a not shown proxy server for transmission of information on the data communication paths in the open domain B. The advantage of this variant is that information which is transmitted in the open communication domain is stored in physical proximity of the end users 5 and can be accessed by these more or less instantaneously via a direct connection between an end user and a mass storage device which stores the transmitted information, e.g. in the form of data with long-term validity or unlimited validity and then particularly information in the form of static data which comprises source information of various types including films, music, text, books etc., and in addition also larger databases.

In this variant there are provided one or more local servers 8 which receive the transmitted information from one or more information providers 4, either via broadband channels 1 or two-way telecommunication lines 2 on the basis of assigned priority protocols for the information which is to be transmitted. As before the information at the global information provider 4 can also be transferred in a memory-to-memory transfer to a memory device, e.g. a transportable mass storage device, which then is brought to the local server, via transport paths 3 such as mail or courier services, etc. Such mass storage devices can in themselves implement the mass storage device in the local server 8 or information transmitted in this manner to the server 8 is transferred further to a permanent local mass storage device in the local server 8. It shall, however, be understood that local mass storage devices of this kind can be expanded as required in order to offer sufficient storage capacity.

In the transmission of information to local servers 8 the priority protocols can be assigned automatically and dependent on the data type be default for the information which shall be transmitted. Such priority protocols can then be assigned according to the same prescriptions on all global information providers 4. In principle it will also be possible for an end user 5 via a local server 8 to request a modified priority protocol, but normally the transmission modes will such that this probably will be less topical. For instance can static information from global information providers 4 be transmitted continuously to the local server 8 which thus is subjected to a continuous updating of the stored information. This corresponds to the continuous transmission to the dedicated communication server 7 as shown in FIG. 2. The transmission capacities on one-way broadband networks 1, possibly also two-way telecommunication lines 2, would be maintained by the information transmission substantially always being restricted to transmit information only once, as it as static information shall have unlimited validity. Simultaneously the transmission can as mentioned take place continuously such that the transmission capacity which is offered in the data communication network e.g. on the basis of information from the network operators, also becomes optimal with regard to the transmission speed and transmission costs.

To each local server 8 one or more end users 5 are connected. In other words a local server 8 at most serves a limited group of end users 5 and this limitation is not relevant for the number, but also in a geographical sense. For instance can typically a local server 8 serve from one to some hundreds or thousands end users 5 in an area which at most has an extension of a few square kilometres, e.g. a part of a town, a city block or a building. This now allows that the transmission from the local server to the separate end user can be implemented on a permanent and dedicated local broadband network, which e.g. may be realized by fibre-optic cables or coaxial cables. But the connection between a local server 8 and end user 5 may also be established via existing cable networks, e.g. the cable television network or the common power supply network. Finally the connection between the local server 8 and end user 5 may also be established by means of arbitrarily chosen transmission lines, preferably via a transmission line which is selected by an end user as required.

With sufficient capacity in a permanent broadband network 9 it is technically and cost-wise now realistic that end user 5 can download all information in the local server 8 to a mass storage device correspondingly provided in the former and access the information directly. Information access shall also take place by the information being downloaded from the local server 8 either on request or under local subscription agreements. The intermittent utilization of information locally in this manner will of course have no consequences for the optimization of the information transmission from global information providers 4 to the local server 8 in the open domain B, as this transmission in principle can take place completely uninfluenced by anything else than end user's permanent need.

As before the end users 5 as users of Internet are connected to the Internet domain A and it can then be used via e.g. ISP 6 as shown in the figure. However, there is nothing to prevent that the local server 8 on its own could implement either a local ISP or a web server and hence be used by its connected end users for ordinary Internet access. This is however, not shown in FIG. 3, but it ought to be obvious to persons skilled in the art that a connection of this kind can be realized.

FIG. 4 shows how communication paths between global information providers 4 and end users 5 can be realized in a fourth variant which combines features from the variant in FIG. 2 and the variant in FIG. 3. As in FIG. 2 a dedicated communication server or node 7 which substantially from the global information provider 4 via the not shown proxy server in the open domain B preferably continuously is supplied with static information over one-way broadband channels 1 or two-way telecommunication lines 2 with an optimal utilization of transmission capacity and transmission speeds, as the priority protocol which is used as before default can be assigned according to the information type and be common for more than one information provider 4. As alternative there is here, however, also shown the use of a physical transport path 3 for physically transporting a transportable memory device from a global information provider 4 to the dedicated information server 8, although this anyway is supposed to be an alternative which will not be used very often. From the dedicated communication server 7 information now is transmitted and stored physically in proximity to the end user 5, one or more end users 5 being connected to respective local servers 8 connected via e.g. permanent and dedicated local broadband networks 9 or other local transmission channels, where the connection between the local server and end user also can be established by the latter. The transmitted static information can thus be accessed by the end user 5 directly being connected to the local server or of course as before by the further downloading of the information and storage thereof on a corresponding mass storage device at the end user 5 for final access therein. Also in this variant the dedicated communication server 7 or the local server 8 can implement a connection to Internet, and operate as web servers, possibly as information providers to Internet although this is not shown in the figure. It is then to be understood that these, of course, must have an interface to the Internet domain A and that communication then also in any case will take place in the Internet domain A, but normally will be limited to e.g. ordinary electronic mail, message exchange or transmission of smaller files which mainly comprise dynamic data or data with short-term validity.

If the transmission of information is not based on some form of subscription, it will usually take place some message traffic between end user and information provider. This message traffic may comprise transmission requests and payment instructions. In addition end user's opportunity to select or modify priority protocols may cause a message exchange between the information provider and end user. Largely the message traffic in connection with the transmission shall at most imply a traffic volume of some hundred bytes to some kilobytes and thus not occupy any transmission capacity worth mentioning. The message traffic can hence take place over the usual telecommunication network using relatively low rate two-way telecommunication lines with low capacity, e.g. via the telephone network or even more expediently via Internet.

It is to be remarked that access in mode III, i.e. with local storage in physical proximity to end user 5 can be realized in all variants shown in FIGS. 1-4. It is of course, a condition that suitable mass storage devices which can be transported physically and implemented on e.g. local servers 8 or end users' data processing devices, are available in the technology and have sufficient storage capacity for storing large volumes of static information including data files which not only contain single works in the form of films, music, or texts, but collections thereof, e.g. libraries which comprises hundreds, possibly thousands of films, music works or books. In case static data make it possible, it is then of course assumed that suitable data compression methods are used, such that static data which are transmitted and stored in a suitable manner, are compressed by means of commercially available compression methods. Such compression methods can be based on standards such as MPEG for video and cinematographic images, JPEG for still images or the derived standard which is MP3 for data files with music and MP4 for both sound and images, but may also be based on proprietary or available commercial compression methods, e.g. such as the one available from Fast Search & Transfer ASA for compression of video files and which offers the possibility of compressing an evening-length movie in standard video format with a factor of 300, i.e. to a file of about 5 Gbit. It is, however, to be understood that mass storage devices of this kind even though they could contribute to realize features of the present invention in a particularly advantageous manner, do not comprise a part of the present invention. Specifications with regard to capacity and yield are, however, easily established by persons skilled in the art and it will be realized that not only large storage capacity is necessary, but mass storage devices of this kind must also allow addressing operations with high speed and large capacity. In this regard well-known mass storage devices as e.g. optical disk (video memories, CD-ROM etc.) and magnetic disk, however, have evident limitations with regard to the tuning of e.g. the transmission capacity which instantaneously is available for transmission in e.g. broadband data networks, and the readout speed from the memory. For instance, a CD-ROM which usually stores 650 Mbyte, may be read in about 4 minutes with maximum speed such that the readout speed in other words is something less than 3 Mbyte/s. If the transmission of static information takes place on request from an end user and it is desirable to utilize an instantaneous capacity on e.g. a one-way broadband channel optimally, this might involve the utilization of non-occupied time slots in broadband channels of this kind, such that data packets could be transmitted batchwise in time slots of this kind with a speed corresponding to several hundred Mbit per second and even more, something which will be possible in e.g. fibre-optical links or satellite links on GHz frequencies.

Thus in order to implement the method according to the present invention in a suitable manner with the use of local mass storage devices, this requires that mass storage devices of this kind not only must be physically transportable and able to store large amounts of information volume, but also that the they can be addressed for reading, preferably also for writing in such a manner that input and output can take place with speeds up to 1 GHz or more. This implies that the at present commercially available optical or magnetic addressable data storage devices will be less satisfying for the purposes of the present invention.

However, there is presently under development by Thin Film Electronics ASA a memory technology which realizes electrically addressable mass storage devices and which will make these available with form factors and dimensions corresponding to a common credit card or standard PCMCIA cards with possibility for storing several Gbyte and even more than 1 Tbyte, and which may be addressed in write and read modes at a rate of 1 Gbit or more. Writing and reading of data to such mass storage devices take place via sets of parallel stripe electrodes which comprises respective word lines and bit lines in the memory devices and with the memory material in sandwich between the word lines and bit lines which are arranged such that they form an orthogonal matrix with the bit locations defined in the cross points of the matrix. These memory devices are realized in an organic thin-film technology which allows their fabrication with very low costs irrespective of storage capacity and hence their availability as a commercially attainable product for any thinkable end user. The addressing capacity will then substantially be a question of cost, but in any circumstance a marginal factor as there already in the prior art are known bus interfaces which offer clock rates of 1 GHz or more. The readout speed will then be 1 bit for each clock cycle and can by using respectively the leading or trailing edge be doubled. If analog coding is used in readout such that the signal sequences are represented by steps in the leading and trailing edge, the write and read speed can even be multiplied several times. This implies that data words without any problems under a suitable timing can be read out with a width corresponding to all bit spots in a word line or even in parallel from several word lines, with the use of suitable multiplexing.

In all circumstances a memory technology of this kind with use of mass storage devices based on organic thin-film technology and with electrical addressing without the use of active components opens for the possibility of implementing storage of data in large scale and make these available for transmission over existing data communication network and access at the end user according to the method of the present invention. This can take place in a manner which will be optimal for all operators with regard to achieve maximum transmission capacity and simultaneously minimize the transmission cost and that without burdening existing data communication resources, such that e.g. ordinary transmission of dynamic data and the ordinary two-way telecommunication traffic shall not be impeded.

1. A method in transmission of information in the form of data files via a data communication network or in the form of data files stored on physically transportable data storage means, wherein the data files comprises digitally encoded information offered by global information providers and also including information which basically is offered on a shared network resource, e.g. Internet, wherein the information essentially comprises dynamic data, quasi-static data, static data or a mixture of such data, wherein the static data includes archival information or source information, including static databases, films, music, text etc. which for the end user's utilization in principle only need to be transmitted once from a global information provider to end user, wherein the transmission of information takes place in an open communication domain which includes proprietary or public data communication networks as well as surface mail systems, and wherein the method is characterized by
classifying information offered with a unique classification key comprising a set of respective qualified quantitative and qualitative classification criteria, such that each data file is assigned a unique classification key,
generating priority protocols for the transmission of data files on the basis of a priority matrix comprising elements formed by two or more qualified criteria for a transmission, the elements of the priority matrix stating valid combinations of these criteria,
assigning each classified data file at least one priority protocol selected among the generated priority protocols on the basis of the classification key for the data file, the at least one priority protocol assigned to a data file determining the conditions whereby transmission of the data file shall take place,
selecting one or more channels for direct or indirect transmission of a data file from a global information provider to one or more end users on the basis of the at least one priority protocol assigned to the data file,
accessing information transmitted in one or more data files in one of the following modes: (I) the data file or the data files are transmitted directly to end user according to the at least one assigned priority protocol or to another priority protocol assigned for the occasion; (II) the data file or data files are transmitted default and automatically to one or more end users according to the at least one assigned priority protocol; (III) the data file or data files are transmitted according to the at least one assigned priority protocol or another priority protocol assigned for the occasion and transmitted information is stored physically in proximity to end user such that information taking place on a mass storage device of a local server which serves one or a limited number of end users or on a corresponding mass storage device of the end user, the information in each case now being accessible over a direct connection between end user and mass storage device.

2. A method according to claim 1,
characterized by the classification key comprising at least the following criteria, viz. information type, age, volume, number of users and user relevancy, each of the criteria being qualified in ranked categories.

3. A method according to claim 1,
characterized by the priority matrix being formed on the basis of at least two of the following criteria for transmission, viz. transmission mode, data rate, transmission cost and delay/urgency, each of the criteria being qualified in ranked categories.

4. A method according to claim 1,
characterized by the priority protocol being assigned to the data files by a global information provider.

5. A method according to claim 4,
characterized by the global information provider in advance determining the priority protocol whereby the transmission in any default case takes place.

6. A method according to claim 4,
characterized by end user from the global information provider being offered a survey of the priority protocols assigned to a data file and on his own chooses the priority protocol whereby the transmission of the data file shall take place.

7. A method according to claim 4,
characterized by end user from the global information provider being offered the choice between several priority protocols for transmission of a data file to end user, such that the transmission takes place with priority protocol selected by end user or with priorities determined by the latter.

8. A method according to claim 1,
characterized by the data files consisting of dynamic data being transmitted dependent on the assigned priority protocol via two-way data communication networks, including two-way data communication networks in a shared network resource.

9. A method according to claim 1,
characterized by data files consisting of static data being transmitted dependent on the assigned priority protocol in the open communication domain by data communication networks optimized for one-way communication with large capacity, the transmission taking place as an only once transmission with high transmission rate, in batches with aggregated medium transmission rate or continuously with a low transmission rate over a longer time period.

10. A method according to claim 1,
characterized by data files consisting of static data being transmitted dependent on the assigned priority protocol in a single operation by the information being transferred to a physically transportable memory device which then is physically transported to end user.

11. A method according to claim 1, wherein end user access takes place in mode III,
characterized by a global information provider delivering the information to local servers and/or end users and by the global information provider transmitting the information to the local server or the end user in at least one of the following modes: (i) the information is transmitted from the information provider to a physically transportable mass storage device in a memory to memory transfer in a data processing device of the information provider and transmitted further to a local server or end user by a physical transport of the transportable mass storage device; (ii) the information is transmitted from the global information provider to a local server or end user via data communication networks which are optimized for one-way transmission with large capacity, such as satellites, ground-based wireless broadband channels or cable-based channels with broadband capacity.

12. A method according to claim 11,
characterized by the transmission taking place upon request from a local server or end user under a priority protocol which is determined on the basis of criteria specified by information provider or end user or both, the priority protocol being wholly or partly default or modified wholly or partly each time.

13. A method according to claim 11,
characterized by the transmission to a local server or end user taking place automatically under a pre-agreed user subscription.

14. A method according to claim 13,
characterized by the pre-agreed user subscription including respectively one or more global information providers and one or more end users.

15. A method according to claim 1, wherein end user access takes place in mode III,
characterized by a global information provider delivering the information to one or more dedicated servers with mass storage capacity, and by a dedicated server transmitting the information to a local server or end user in at least one of the following modes: (iii) the information is transmitted from the dedicated server to a physically transportable mass storage device in a memory to memory transfer in a data processing device of the dedicated server and transferred further to a local server or end user by a physical transport of the transportable mass storage device; (iv) the information is transmitted from the dedicated server to a local server or end user via data communication networks which are optimized for one-way transmission with large capacity such as satellite channels, ground-based wireless broadband channels or cable-based channels with broadband capacity.

16. A method according to claim 15,
characterized by the transmission taking place upon request from a local server or end user under a priority protocol which is determined on the basis of criteria specified by the global information provider or end user or both, the priority protocol being partly or wholly default or modified partly or wholly each time.

17. A method according to claim 15,
characterized by the transmission to a local server or end user taking place automatically under a pre-agreed user subscription.

18. A method according to claim 17,
characterized by the pre-agreed user subscription including respectively one or more information providers and one or more end users.

19. A method according to claim 1, wherein access takes place in mode III and the information is stored on a local server,
characterized by a direct connection for information access between the local server and end user taking place over a dedicated local broadband network or an arbitrarily selected connection between a local server and end user, the latter connection preferably being established by end user.

20. A method according to claim 1,
characterized by the transmitted information being searched by end user with a search engine and search index implemented on the local server or at the end user.

21. A method according to claim 20,
characterized by the search index being generated by one of the following, viz. the global information provider, the local server or a dedicated server.

22. A method according to claim 20, wherein the information is transmitted on a physically transportable mass storage device, characterized by the search engine and the search index being integrated on the physically transportable mass storage device.

23. A method according to claim 1,
characterized by the end user searching the transmitted information with a search engine for non-indexed search.

24. A method according to claim 23, wherein the information is transmitted on a physically transportable mass storage device, characterized by the search engine for non-indexed search being integrated on the physically transportable mass storage device.
